(19) United States
(12) Patent Application Publication
(10) Pub. No.: US 2003/0017937 A1
(43) Pub. Date: Jan. 23, 2003

(54) Process for preparing metal containing bi-functional catalysts for dewaxing

(76) Inventors: Son-Ki Ihm, Seoul (KR); Kwang-Cheon Park, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 09/904,261

(22) Filed: Jul. 11, 2001

(51) Int. Cl. B01J 29/06; B01J 21/08

(52) U.S. Cl. 502/66; 502/64

(57) ABSTRACT

The present invention relates to a process for preparing metal containing bi-functional catalyst for dewaxing and metal containing bi-functional catalysts prepared by the process. The process for preparing metal containing bi-functional catalyst of the invention comprises the steps of: reacting silica with aqueous alkali metal solution to obtain aqueous alkali metal silicate solution, adding the aqueous alkali metal silicate solution to a template in a dropwise, followed by hydrothermal synthesis to obtain MCM-41 support, calcining precipitate formed by mixing the MCM-41 support with Al precursor to obtain Al-MCM-41 and, incorporating metal followed by calcination. The metal containing bi-functional catalyst catalyzes isomerization rather than cracking in the conversion of n-hexadecane, which makes possible its practical usage as a dewaxing catalyst of lubricating oil and diesel oil.

### FIELD OF THE INVENTION

The present invention relates to a process for preparing metal containing bi-functional catalysts for dewaxing and metal containing bi-functional catalysts prepared by the process, more specifically, to a process for preparing metal containing bi-functional catalysts by reacting silica with aqueous alkali metal solution to obtain aqueous alkali metal silicate solution, adding the aqueous alkali metal silicate solution to a template, followed by hydrothermal synthesis to obtain MCM-41 support, calcining precipitate formed by mixing the MCM-41 support with Al precursor to obtain Al-MCM-41 and, incorporating metal followed by calcination, and metal containing bi-functional catalysts prepared by the process.

### BACKGROUND OF THE INVENTION

In general, wax is referred to as straight chain hydrocarbons with a carbon number from 30 to 40. Because wax contained in lubricating or diesel oil decreases their efficiency at low temperatures, it should be removed by dewaxing in the course of oil manufacturing.

Dewaxing is largely classified into two types: a solvent dewaxing process employing a solvent and a contact dewaxing process employing a catalyst. In the solvent dewaxing process, which is a widely used conventional method, the wax is removed by selective dissolution in solvents such as methylethyl ketone (MEK) and liquid propane. This method, however, has been proved less satisfactory in the sense of time and expenses. In this regard, the contact dewaxing process using a catalyst was recently developed and has been actively studied in light of its attracting features including low environmental expenses in solvent disposal.

The contact dewaxing process was first applied to kerosene and gasoline by Mobil Corporation(U.S.A.) in late 1970s, and named as MDDW (Mobil middle distillate dewaxing) process. This process has been applied to lubricating oil to develop MLDW (Mobil lube dewaxing) process in 1980s, in which ZSM-5, a synthetic zeolite catalyst with strong acidity, was used to remove wax by cracking it into low hydrocarbons. In 1992, Chevron Corp. has developed a zeolite catalyst where platinum is supported on SAPO-11, to improve the yield and viscosity of lubricating oil. However, in practical dewaxing processes, isomerization is preferred to the cracking reaction. Therefore, the prior art catalysts that crack wax into small hydrocarbons have limited effects in improving the efficiency of lubricating oil.

For this reason, the studies have been continued on the catalysts that promote isomerization rather than cracking in dewaxing processes. Beck et al. have developed MCM-41 support with meso-scale pores and prepared Al-MCM-41 by adding aluminum to mother liquor of the support obtained during the preparation of MCM-41 support followed by hydrothermal synthesis (see: U.S. Pat. No. 5,057,296). However, this method was hard to be commercialized due to low hydrothermal stability. Alternatively, Ryong Ryoo et al. have obtained MCM-41 with high hydrothermal stability by adjusting pH of a solution employed in hydrothermal synthesis (see: U.S. Pat. No. 5,942,208), and prepared Al-MCM-41 by incorporating Al into MCM-41, which is named as post-synthetic metal implantation (see: Chem. Commun., 1997, 2225). D. Rossi et al. have also developed metal/Al-MCM-41 bi-functional catalyst by incorporating a metal into Al-MCM-41, which is prepared by adding Al to mother liquor of MCM-41 support in the preparation of support (see: U.S. Pat. No. 5,256,277). However, the said processes have been only applied to isomerize low hydrocarbons with C₄-C₈, and have limitations in isomerizing wax with large carbon numbers.

Under the circumstances, to overcome the defects of the prior art processes, there are strong reasons for developing and exploring novel catalysts that can effectively isomerize high hydrocarbons such as wax.

### SUMMARY OF THE INVENTION

The present inventors have made an effort to develop a process for preparing catalysts with superior isomerization capacity, and discovered that bi-functional catalysts with high isomerization ratio of wax can be prepared by the post-synthetic incorporation of Al and metal into a hydrothermally stable MCM-41 support in the preparation of metal/Al-MCM-41 catalysts.

A primary object of the present invention is, therefore, to provide a process for preparing metal containing bi-functional catalysts for dewaxing.

The other object of the invention is to provide bi-functional catalysts prepared by the process.

### BRIEF DESCRIPTION OF DRAWINGS

The above and the other objects and features of the present invention will become apparent from the following descriptions given in conjunction with the accompanying drawings, in which:

FIG. 1 is a graph showing the time course of conversion ratios of n-hexadecane for Pt/Al-MCM-41 catalysts with different Si/Al ratios.

FIG. 2 is a graph showing the time course of conversion (cracking+isomerization) ratios of n-hexadecane for Pt/Al-MCM-41 catalysts and conventional catalysts.

FIG. 3 is a graph showing the isomerization ratio curves against the conversion ratio of n-hexadecane for Pt/Al-MCM-41 catalysts and conventional catalysts.

### DETAILED DESCRIPTION OF THE INVENTION

The process for preparing metal containing bi-functional catalysts of present invention comprises the steps of reacting silica with aqueous alkali metal solution to obtain aqueous alkali metal silicate solution, adding the aqueous alkali metal silicate solution to a template in a dropwise, followed by hydrothermal synthesis to obtain MCM-41 support, calcining precipitate formed by mixing the MCM-41 support with Al precursor dissolved in an organic solvent to obtain Al-MCM-41 and, incorporating metal by immersing the Al-MCM-41 into a solution of VIII family metal precursor followed by calcination.

The process for preparing metal containing bi-functional catalysts of the present invention is illustrated in more detail by the following steps.

Step 1: Preparation of Alkali Metal Silicate

Aqueous alkali metal silicate solutions are obtained by reacting silica with aqueous alkali metal solution: The silica may be one or more selected from the group consisting of fumed silica, aerosil, and tetraorthosilicate, though silica sold under the trademark of HS-40(Ludox HS-40) or Ludox AS-30 from DuPont is preferred. The alkali metal includes the elements that belong to IA family in chemical periodic table, though lithium (Li), sodium (Na), or potassium (K) is preferred, and sodium is more preferred.

Step 2: Preparation of MCM-41 Support

MCM-41 support is prepared by the dropwise addition of alkali metal silicate solution obtained in Step 1 to a template, followed by hydrothermal synthesis: The template is chemical materials that facilitate the formation of micelle, a chemically stable intermediate, to yield uniform pore structures in the preparation of support, which includes octadecyltrimethylammonium bromide (C₁₈TMABR), cetyltrimethylammonium chloride (C₁₆TMACL), myristyltrimethylammonium chloride (C₁₄TMACL), dodecyltrimethylammonium bromide (C₁₂TMABR), decyltrimethylammonium bromide (C₁₀TMABR), octyltrimethylammonium bromide (C₈TMABR), or hexyltrimethylammonium bromide (C₆TMABR), or a mixture of these compounds. The hydrothermal synthesis is used to increase the growth rate of crystals by heating the water containing mixture, where the mixture is reacted at a high pressure generated by heating in a sealed container. MCM-41 is decomposed at high temperatures in the presence of water. To solve the said problem, pH of the reaction solution is preferably adjusted at the range of 9 and 11 by using hydrochloric acid (HCl) or acetic acid.

Upon completion of the hydrothermal synthesis, the resulting precipitate is filtered, washed, and then dried using the conventional methods to give MCM-41 support. The pore size in the support can be controlled by changing the template, and the average pore size of 1.5 to 20 nm is preferred. If the average diameter is smaller than 1.5 nm, it is hard for the surfactant to form micelles in the liquid mixture, to make the pore structure hardly grow. On the other hand, if the average diameter is larger than 20 nm, the pore structure in MCM-41 is hardly formed, and the structure is easily decomposed due to the low stability of the framework.

Step 3: Preparation of Al-MCM-41

Al-MCM-41 is prepared by calcining the precipitate formed by mixing the MCM-41 support with Al precursor dissolved in an organic solvent: The organic solvent includes ethanol, methanol, propanol, and acetone, and mixture thereofs, though ethanol is the most preferred due to the low toxicity and high dissolving power for metal precursors. The Al precursor includes AlCl₃, Al(OH)₃, Al(OCH₃)₃, or mixture thereofs, most preferably, AlCl₃ with high reactivity, which is preferably added to yield Si/Al mole ratio of between 1 and 200 in the final product Al-MCM-41. If the Si/Al mole ratio is smaller than 1, the reactivity does not increase and the structure is decomposed because aluminum is not incorporated into MCM-41 framework and stays in oxidative state, i.e., alumina. If the Si/Al mole ratio is larger than 200, the reactivity is low because the amount of introduced acidic points is too small. That is, both cases are not preferable to accomplish the objects of present invention. The precipitate is filtered, washed, and dried by the conventional method, followed by calcination at the temperature of 350 to 800° C. for 2 to 24 hours. If the calcination temperature is below 350° C., Al cannot be incorporated into the framework, and if the temperature is over 800° C., then MCM-41 framework degradates. If the calcination is carried out for less than 2 hours, Al cannot be incorporated into the framework sufficiently and the calcination over 48 hours may degradates the structure.

Step 4: Preparation of Metal/Al-MCM-41 Bi-Functional Catalysts

Metal/Al-MCM-41 bi-functional catalysts are prepared by calcination after metal incorporation by immersing the Al-MCM-41 obtained in Step 3 into VIII family metal precursor solution prior to calcination: VIII family metals are reduced by hydrogen, which causes hydrogenation and dehydrogenation. Platinum (Pt), palladium (Pd), or nickel (Ni) is preferred due to the low possibility of carbon-carbon bond breaking side reaction. The elements such as platinum (Pt), palladium (Pd), and nickel (Ni) are impossible to be incorporated in a solid state, and they should be incorporated into Al-MCM-41 as in the forms of precursors. The precursors of these metals are more than one compounds selected from the group consisting of Pt(NH₃)₅.ClH₂O, Pt(NH₃)₄.Cl₂.H₂O, Pt(NH₃)₃.Cl₃.H₂O, Pt(NH₃)₂.Cl₄.H₂O, Pt(NH₃).Cl₅.H₂O, PtCl₆, PtCl₄, PtCl₂, PtS₂, PtSO₄, P₃(NH₃)₅.Cl₂.H₂O, Pd(NH₃)₄.Cl₂.H₂O, Pd(NH₃)₃.Cl₃.H₂O, Pd(NH₃)₂.Cl₄.H₂O, Pd(NH₃).Cl₅.H₂O, PdCl₆, PdCl₄, PdCl₂, PdS₂, PdSO₄, Ni(NH₃)₅.Cl.H₂O, Ni(NH₃)₄.Cl₂.H₂O, Ni(NH₃)₃.Cl₃.H₂O, Ni(NH₃)₂.C₄.H₂O, Ni(NH₃).Cl₅.H₂O, NiCl₆, NiCl₄, NiCl₂, NiS₂ and NiSO₄. The amount of the incorporated metal should be set for metal/(metal+Al-MCM-41) mass ratio of 0.0001 to 0.15. If the metal/(metal+Al-MCM-41) ratio is smaller than 0.0001, only small number of metal points are formed, to afford low hydrogenation-dehydrogenation. As a result, the cracking reaction becomes the major reaction. The ratio larger than 0.15 is not preferred because the amount of exposed metal points does not increase even though the amount of metal increases due to the low dispersion rate of metals. Al-MCM-41 immersed in the metal precursor solutions is filtered, dried by the conventional method in the art, and calcined in an analogous manner as in Step 3.

The order of the step of incorporating metals by the addition of VIII family metal precursors (Step 4) may be changed within the spirit of present invention, for example, VIII family metal precursor solution is added dropwise after aqueous silicate solution is added to a template (metal pre-synthesis).

The present invention is further illustrated in the following examples, which should not be taken to limit the scope of the invention.

### EXAMPLE 1

### Preparation of Pt/Al-MCM-41 Catalyst by Post-Synthetic Metal Implantation

An aqueous sodium silicate solution was obtained by heating a mixture of 14.3 g Ludox HS-40 (DuPont, U.S.A.), a colloidal silica, and 51.1 ml of 1M NaOH solution at 80° C. for 2 hours. The aqueous sodium silicate solution was added in a dropwise to 25% (w/w) aqueous solution of cetyltrimethylammonium chloride for 1 hour, and then the mixture was hydrothermally-synthesized at 100° C. for 2 days to give siliceous MCM-41 crystals. After the mixture was cooled to room temperature, pH of the mixture was adjusted to 10 with 1M CH₃COOH solution, and the hydrothermal synthesis was repeated. The resulting precipitate was filtered, washed several times with distilled water at 80° C., and then dried at 110° C. to prepare MCM-41 support. The support was fully dried at 140° C. for 10 hours or 100° C. in vacuum oven for 10 hours to remove water in support, 5 g of which was added to 300 ml solution of AlCl₃ in anhydrous ethanol. After stirring for 1 hour, the mixture was filtered, washed with ethanol, and dried at 110° C. The MCM-41 support thus obtained was then calcined at 550° C. for 10 hours to give Al-MCM-41 with the mole ratio of 5, 20, 40, or 80. The ratio of Si/Al was controlled by dissolving different amounts of AlCl₃ into anhydrous ethanol. Finally, Al-MCM-41 was immersed into a liquid platinum precursor Pt(NH₃)₄.H₂O (tetraamineplatinum (II) chloride hydrate, 98%), and platinum was impregnated until the metal/(metal+Al-MCM-41) weight ratio becomes 0.005, and subsequently calcinated at 350° C. for 10 hour to give metal/Al-MCM-41 bi-functional catalysts.

The BET surface area of the catalysts thus prepared was measured by nitrogen adsorption method, which revealed that they have a high surface area of more than 1100 m³/g. The distance between the frameworks (d-spacing) and the pore size measured by X-ray diffraction analysis were 3.8 nm and 2.8 nm, respectively. To test the acidity of the catalysts, ammonia temperature-programmed desorption method was performed to display a peak at 260° C., which implies weak acidity. The dispersion of platinum was examined by using CO chemisorption and electron microscope. The dispersion of the platinum was about 58%, and the average size of the platinum was measured as 3.3 nm.

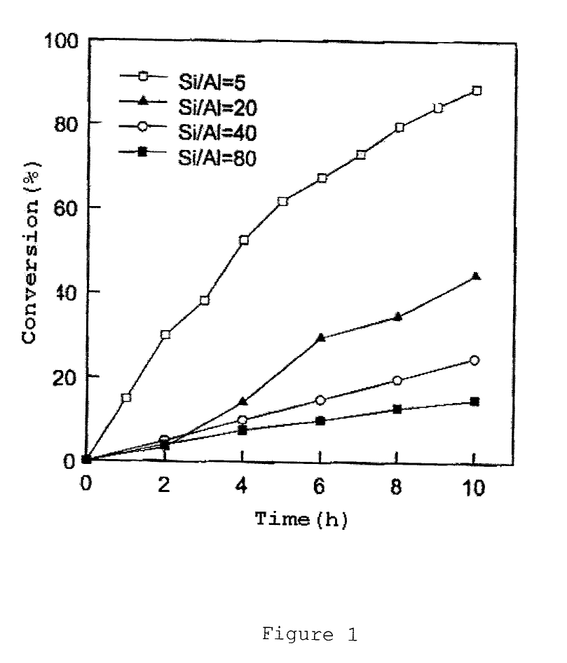

Then, chemical activities of the catalysts for dewaxing reaction was tested using n-hexadecane with 16 carbons as a model compound of wax: First, 0.5 g of each catalyst was placed in a 300 ml batch reactor and then the metal was reduced with hydrogen at 320° C. After introducing 50 ml of n-hexadecane under an environment of hydrogen gas, the temperature of the reactor was increased to 350° C. and the pressure was adjusted to 103bar to isomerize n-hexadecane. The samples were collected during the reaction, and analyzed with gas chromatography(HP 6890 gas chromatography from Hewlett-Packard with 50m HP-1 column)(see: FIG. 1).

FIG. 1 is a graph showing the time course of conversion ratios of n-hexadecane for Pt/Al-MCM-41 catalysts with different Si/Al ratios. In FIG. 1, (□), (▴), (◯), and (▪) represent the results of Si/Al ratios of 5, 20, 40, and 80, respectively. As shown in FIG. 1, as Si/Al ratio decreases in Pt/Al-MCM-41 catalyst(i.e., as the amount of Al added increases), the conversion ratio of n-hexadecane increases in the n-hexadecane isomerization reaction.

### EXAMPLE 2

### Preparation of Pt/Al-MCM-41 Catalysts by Pre-Synthetic Metal Implantation

An aqueous sodium silicate solution was obtained in an analogous manner as in Example 1, and added in a dropwise to an aqueous cetyltrimethylammonium chloride solution (25 (w/w) %). To this mixture was added in a dropwise Pt(NH₃)₄.H₂O as a platinum precursor to give metal/(metal+Al-MCM-41) weight ratio of 0.005. Metal/Al-MCM-41 bi-functional catalysts were prepared analogously as in Example 1 (except for Step 4), in the process following pH adjustment.

For these catalysts, the conversion ratio of n-hexadecane was evaluated as in Example 1, whose results were summarized in Table 1 below, while comparing with Pt/Al-MCM-41(Si/Al=5) catalyst prepared in Example 1. As shown in Table 1, Pt/Al-MCM-41 catalyst prepared by pre-synthetic platinum implantation has slightly higher n-hexadecane conversion ratio and slightly lower selectivity for the isomerization reaction, when compared with Pt/Al-MCM-41 catalyst prepared by post-synthetic implantation, and both catalysts show almost the same performances.

TABLE 1
Conversion ratio of n-hexadecane(350° C., 103 bar)

| | | |
|---|---|---|
| Catalyst | Pt/Al-MCM- | Pt/Al-MCM- |
| | 41 | 41 |
| Preparation method | Post- | Pre- |
| | synthetic | synthetic |
| Conversion ratio | 37.9 | 40.0 |
| Selectivity to iso-hexadecane | 98.2 | 95.5 |
| Iso-hexadecane with one branch | 72.6 | 55.5 |
| (methylpentadecane) | (61.1) | (47.8) |
| Iso-hexadecane with two branches | 21.0 | 27.7 |
| Iso-hexadecane with three branches | 4.6 | 12.3 |
| Selectivity tO hydrocracking for | 1.8 | 4.5 |
| C ≦ 15 | | |

### EXAMPLE 3

### Activity of Pt/Al-MCM-41 Catalysts for Isomerization Reaction

As explained as aboves, cracking and isomerization reactions occur during dewaxing, however, the isomerization reaction is preferred to the cracking reaction in light of the performances and qualities. In the present example, the Pt/Al-MCM-41 catalyst(Si/Al=5) prepared in Example 1 was compared with conventional dewaxing catalysts for isomerization activity.

For conventional catalysts, Pt/ZSM-5, Pt/ZSM-22, Pt/SAPO-11, and Pt/H-Y were evaluated, where Pt/ZSM-5, Pt/ZSM-22, and Pt/SAPO-11 were prepared by the processes described in U.S. Pat. No. 4,139,600, U.S. Pat. No. 3,702,886 and U.S. Pat. No. 4,310,440, respectively, and Pt/H-Y was purchased from Strem Corporation, U.S.A. All of the catalysts were prepared by incorporating platinum in the same weight ratio of 0.005 against the support.

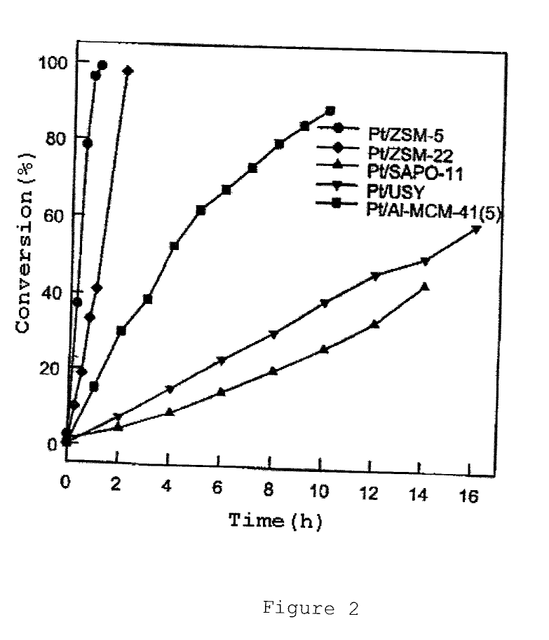

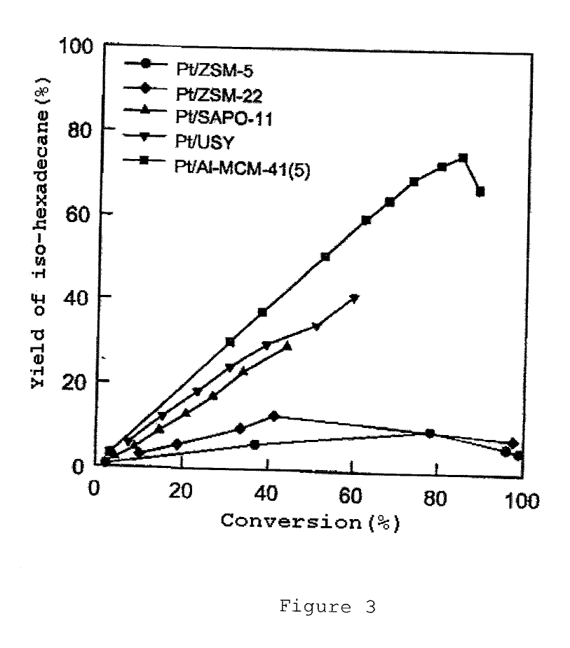

These catalysts were employed for n-hexadecane reaction in a similar fashion as in Example 1, and the conversion ratio of cracking or isomerization was measured in the course of reaction (see: FIG. 2), and yield of iso-hexadecane against conversion ratio was also measured (see: FIG. 3). FIG. 2 is a graph showing the time course of conversion (cracking+isomerization) ratios of n-hexadecane for each catalyst, wherein (●), (♦), (▴), (▾), and (▪) represent the results of Pt/ZSM-5, Pt/ZSM-22, Pt/SAPO-11, Pt/USY, and Pt/Al-MCM-41(5), respectively. FIG. 3 is a graph showing the isomerization ratios against the conversion ratio, wherein (●), (♦), (▴), (▾), and (▪) represent the results of Pt/ZSM-5, Pt/ZSM-22, Pt/SAPO-11, Pt/USY, and Pt/Al-MCM-41(5), respectively. In FIG. 2, Pt/ZSM catalysts are superior in terms of n-hexadecane conversion ratio by cracking and isomerization. However, as shown in FIG. 3, isomerization yields for Pt/Al-MCM-41 catalysts are superior to conventional catalysts. Also, for Pt/ZSM catalysts, most of the conversion was caused by the cracking reaction. Therefore, it was clearly demonstrated that the catalysts of present invention are more appropriate for dewaxing processes.

As clearly described and demonstrated above, the present invention provides a process for preparing metal containing bi-functional catalysts by reacting silica with aqueous alkali metal solution to obtain aqueous alkali metal silicate solution, adding the aqueous alkali metal silicate solution to a template in a dropwise, followed by hydrothermal synthesis to obtain MCM-41 support, calcining precipitate formed by mixing the MCM-41 support with Al precursor to obtain Al-MCM-41 and, incorporating metal followed by calcination, and metal containing bi-functional catalysts prepared by the process. The metal containing bi-functional catalyst catalyzes isomerization rather than cracking in the conversion of n-hexadecane, which makes possible its practical usage as a dewaxing catalyst of lubricating oil and diesel oil.

Although the preferred embodiments of the present invention have been enclosed for illustrative purpose, those who are skilled in the area will appreciated that various modifications, additions, and substitutions are possible without departing from the scope and spirit of the invention as disclosed in the accompanying claims.

What is claimed is:

1. A process for preparing metal/Al-MCM-41 bi-functional catalyst, which comprises the steps of:
(i) reacting silica with aqueous alkali metal solution to obtain aqueous alkali metal silicate solution;
(ii) adding the aqueous alkali metal silicate solution to a template in a dropwise, followed by hydrothermal synthesis to obtain MCM-41 support;
(iii) calcining precipitate formed by mixing the MCM-41 support with Al precursor dissolved in an organic solvent to obtain Al-MCM-41; and,
(iv) incorporating metal by immersing the Al-MCM-41 into a solution of VIII family metal precursor followed by calcination.

2. The process for preparing metal/Al-MCM-41 bi-functional catalyst of claim 1, wherein the silica is more than one selected from the group consisting of fumed silica, aerosil, and tetraorthosilicate.

3. The process for preparing metal/Al-MCM-41 bi-functional catalyst of claim 1, wherein the silica is Ludox HS-40 or Ludox AS-30.

4. The process for preparing metal/Al-MCM-41 bi-functional catalyst of claim 1, wherein the alkali metal is selected from the group consisting of lithium (Li), sodium (Na), and potassium (K).

5. The process for preparing metal/Al-MCM-41 bi-functional catalyst of claim 1, wherein the template is more than one selected from the group consisting of octadecyltrimethylammonium bromide (C₁₈TMABR), cetyltrimethylammonium chloride (C₁₆TMACL), myristyltrimethylammonium chloride (C₁₄TMACL), dodecyltrimethylammonium bromide (C₁₂TMABR), decyltrimethylammonium bromide (C₁₀TMABR), octyltrimethylammonium bromide (C₈TMABR), and hexyltrimethylammonium bromide (C6TMABR).

6. The process for preparing metal/Al-MCM-41 bi-functional catalyst of claim 1, wherein the hydrothermal synthesis is carried out at the pH range of 9 and 11.

7. The process for preparing metal/Al-MCM-41 bi-functional catalyst of claim 1, wherein the MCM-41 support has a pore size of average diameter of 1.5 to 20 nm.

8. The process for preparing metal/Al-MCM-41 bi-functional catalyst of claim 1, wherein the Al precursor is more than one selected from the group consisting of AlCl₃1 Al(OH) 3, and Al(OCH₃)₃.

9. The process for preparing metal/Al-MCM-41 bi-functional catalyst of claim 1, wherein the mole ratio of Si/Al is 1 to 200.

10. The process for preparing metal/Al-MCM-41 bi-functional catalyst of claim 1, wherein the calcination is carried out at the temperature of 350 to 800° C. for 2 to 48 hours.

11. The process for preparing metal/Al-MCM-41 bi-functional catalyst of claim 1, wherein the VIII family metal precursor is more than one compound selected from the group consisting of Pt(NH₃)₅.Cl.H₂O, Pt(NH₃)₄.Cl₂.HO, Pt(NH₃)₃.Cl₃.H₂O, Pt(NH₃)₂.Cl₄.H₂, Pt(NH₃).Cl₅.H₂O, PtCl₆, PtCl₄, PtCl₂, PtS₂, PtSO₄, Pd(NH₃)₅.Cl.H₂O, Pd(NH₃)₄.Cl₂.H₂O, Pd(NH₃)₃.Cl₃.H₂O, Pd(NH₃)₂.Cl₄.H₂O, Pd(NH₃).Cl₅.H₂O, PdCl₆, PdCl₄, PdCl₂, PdS₂, PdSO₄, Ni(NH₃)₅.Cl.H₂O, Ni(NH₃)₄.Cl₂.H₂O, Ni(NH₃)₃.Cl₃.H₂O, Ni(NH₃)₂.Cl₄.H₂O, Ni(NH₃).Cl₅.H₂O, NiCl₆, NiCl₄, NiCl₂, NiS₂ and NiSO₄.

12. A process for preparing metal/Al-MCM-41 bi-functional catalyst, which comprises the steps of:
(i) reacting silica with aqueous alkali metal solution to obtain aqueous alkali metal silicate solution;
(ii) adding the aqueous alkali metal silicate solution to a template in a dropwise and mixing the alkali metal silicate solution with the template;
(iii) adding VIII family metal precursor solution to the mixture, followed by hydrothermal synthesis to obtain metal containing MCM-41 support; and,
(iv) calcining precipitate formed by mixing Al precursor dissolved in an organic solvent to the metal containing MCM-41 support.

13. The process for preparing metal/Al-MCM-41 bi-functional catalyst of claim 12, wherein the silica is more than one selected from the group consisting of fumed silica, aerosil, and tetraorthosilicate.

14. The process for preparing metal/Al-MCM-41 bi-functional catalyst of claim 12, wherein the silica is Ludox HS-40 or Ludox AS-30.

15. The process for preparing metal/Al-MCM-41 bi-functional catalyst of claim 12, wherein the alkali metal is selected from the group consisting of lithium (Li), sodium (Na), and potassium (K).

16. The process for preparing metal/Al-MCM-41 bi-functional catalyst of claim 12, wherein the template is more than one selected from the group consisting of octadecyltrimethylammonium bromide (C₁₈TMABR), cetyltrimethylammonium chloride (C₁₆TMACL), myristyltrimethylammonium chloride (C₁₄TMACL), dodecyltrimethylammonium bromide (C₁₂TMABR), decyltrimethylammonium bromide (C₁₀TMABR), octyltrimethylammonium bromide (C8TMABR), and hexyltrimethylammonium bromide (C₆TMABR).

17. The process for preparing metal/Al-MCM-41 bi-functional catalyst of claim 12, wherein the hydrothermal synthesis is carried out at the pH range of 9 and 11.

18. The process for preparing metal/Al-MCM-41 bi-functional catalyst of claim 12, wherein the metal containing MCM-41 support has a pore size of average diameter of 1.5 to 20 nm.

19. The process for preparing metal/Al-MCM-41 bi-functional catalyst of claim 12, wherein the Al precursor is more than one selected from the group consisting of AlCl₃, Al(OH)₃, and Al(OCH₃)₃.

20. The process for preparing metal/Al-MCM-41 bi-functional catalyst of claim 12, wherein the mole ratio of Si/Al is 1 to 200.

21. The process for preparing metal/Al-MCM-41 bi-functional catalyst of claim 12, wherein the calcination is carried out at the temperature of 350 to 800° C. for 2 to 48 hours.

22. The process for preparing metal/Al-MCM-41 bi-functional catalyst of claim 12, wherein the VIII family metal precursor is more than one selected from the group consisting of Pt(NH₃)₅.Cl.H₂O, Pt(NH₃)₄.Cl₂.H₂O, Pt(NH₃)₃.Cl₃.H₂O, Pt(NH₃)₂.Cl₄.H₂O, Pt(NH₃).Cl₅.H₂O, PtCl₆, PtCl₄, PtCl₂, PtS₂, PtSO₄. Pd(NH₃)₅.Cl.H₂O, Pd(NH₃)₄.Cl₂.H₂O, Pd(NH₃)₃.Cl₃.H₂O, Pd(NH₃)₂.Cl₄.H₂O, Pd(NH₃).Cl₅.H₂O, PdCl₆, PdCl₄, PdCl₂, PdS₂, PdSO₄, Ni(NH₃)₅.Cl.H₂O, Ni(NH₃)₄.Cl₂.H₂O, Ni(NH₃)₃.Cl₃.H₂O, Ni(NH₃)₂.Cl₄.H₂O, Ni(NH₃).Cl₅.H₂O, NiCl₆, NiCl₄, NiCl₂, NiS₂ and NiSO₄.

23. Metal/Al-MCM-41 bi-functional catalyst prepared by the process of claim 1, whose metal/(metal+Al-MCM-41) mass ratio ranges between 0.0001 and 0.15.
